(19) United States
(12) Patent Application Publication
(10) Pub. No.: US 2024/0242542 A1
(43) Pub. Date: Jul. 18, 2024

(54) GESTURE RECOGNITION DEVICE

(71) Applicant: Quanta Computer Inc., Taoyuan City (TW)

(72) Inventors: Ko-Chien CHUANG, Taoyuan City (TW); Yu-Hsin CHOU, Taoyuan City (TW); Chih-Yi HUANG, Taoyuan City (TW); Shao-Fan WANG, Taoyuan City (TW)

(21) Appl. No.: 18/450,611

(22) Filed: Aug. 16, 2023

(30) Foreign Application Priority Data
Jan. 12, 2023 (TW) 112101290

(51) Int. Cl. G06V 40/20; G06F 3/01

(52) U.S. Cl. CPC G06V 40/28; G06F 3/017

(57) ABSTRACT

An embodiment of the invention provides a gesture recognition device. The gesture recognition device may include an image extraction device, a storage circuit and a recognition circuit. The image extraction device may extract a first gesture image. The storage circuit may store a plurality of gesture patterns. The recognition circuit may obtain the first gesture information corresponding to the first gesture image according to the first gesture image, select a gesture pattern corresponding to the first gesture image from the gesture patterns according to the first gesture information, and perform the function that corresponds to the selected gesture pattern.

### CROSS REFERENCE TO RELATED APPLICATIONS

This Application claims priority of TW Patent Application No. 112101290 filed on Jan. 12, 2023, the entirety of which is incorporated by reference herein.

### BACKGROUND OF THE INVENTION

### Field of the Invention

The invention generally relates to gesture recognition technology, and more particularly, to a gesture recognition technology in which a gesture recognition device with a camera is used to perform gesture recognition.

### Description of the Related Art

As technology continue to progress, the applications for wearable devices equipped with augmented reality (AR) have become more mature.

Traditionally, when gesture recognition needs to be performed on an AR device, the AR device may need to be configured with many powerful and complex function modules, and the AR device may need to be configured with Light-Detection-And-Ranging (Lidar) and a plurality of lenses to detect, recognize, and track the complex gestures. Although the powerful function modules may provide more accurate gesture recognition, the powerful function modules may need to perform more complex calculations. Therefore, if the powerful function modules are used on the AR device, the weight and the battery life of the AR device will be affected, and a latency may be generated on the operations of the AR device. In addition, the requirements on the Lidar and the lenses may impede the user from using an AR device with a simple hardware configuration to perform gesture recognition.

Therefore, how to more easily perform gesture recognition is a topic that is worthy of discussion.

### BRIEF SUMMARY OF THE INVENTION

A gesture recognition device and method are provided to overcome the problems mentioned above.

An embodiment of the invention provides a gesture recognition device. The gesture recognition device may include an image extraction device, a storage circuit and a recognition circuit. The image extraction device may extract a first gesture image. The storage circuit may store a plurality of gesture patterns. The recognition circuit may obtain the first gesture information corresponding to the first gesture image according to the first gesture image, select a gesture pattern corresponding to the first gesture image from the gesture patterns according to the first gesture information, and perform the function that corresponds to the selected gesture pattern.

According to an embodiment, the gesture recognition device may further include an optical machine device. The optical machine device may display a display result corresponding to the function.

According to an embodiment, the gesture patterns may comprise a plurality of static gesture patterns and a plurality of dynamic gesture patterns. Each dynamic gesture pattern corresponds to one of the static gesture patterns. The recognition circuit may select a static gesture pattern corresponding to the first gesture image from the static gesture patterns according to the first gesture information.

According to an embodiment, the recognition circuit may further obtain the second gesture information corresponding to a second gesture image according to the second gesture image extracted by the image extracting device at the next time point. In addition, recognition circuit may further determine whether the second gesture image corresponds to a dynamic gesture pattern corresponding to the selected static gesture pattern according to the first gesture information and the second gesture information.

In an embodiment, when the recognition circuit may determine that the second gesture image corresponds to the dynamic gesture pattern corresponding to the selected static gesture pattern, the recognition circuit may perform the function corresponding to the dynamic gesture pattern.

In another embodiment, when the recognition circuit may determine that the second gesture image does not correspond to the dynamic gesture pattern corresponding to the selected static gesture pattern, the recognition circuit may perform the function corresponding to the static gesture pattern corresponding to the second gesture image.

According to an embodiment, the recognition circuit may further select the static gesture pattern corresponding to the first gesture image from the static gesture patterns according to a classification tree.

According to an embodiment, the recognition circuit further obtains the first gesture information corresponding to the first gesture image according to a deep learning algorithm.

According to an embodiment, the first gesture information may comprise angle information and direction information corresponding to the user's fingers.

An embodiment of the invention provides a gesture recognition method. The gesture recognition method may be applied to a gesture recognition device. The gesture recognition method may include following steps. Then, the gesture recognition device may extract a first gesture image. Then, the gesture recognition device may obtain the first gesture information corresponding to the first gesture image according to the first gesture image. Then, the gesture recognition device may select a gesture pattern corresponding to the first gesture image from the gesture patterns according to the first gesture information. Then, the gesture recognition device may perform the function that corresponds to the selected gesture pattern.

Other aspects and features of the invention will become apparent to those with ordinary skill in the art upon review of the following descriptions of specific embodiments of a gesture recognition device and method.

### BRIEF DESCRIPTION OF THE DRAWINGS

The invention will become more fully understood by referring to the following detailed description with reference to the accompanying drawings, wherein:

FIG. 1 is a block diagram of a gesture recognition device 100 according to an embodiment of the invention;

FIG. 2 is a schematic diagram illustrating static gesture patterns and dynamic gesture patterns according to an embodiment of the invention;

FIG. 3 is a block diagram of the recognition circuit 130 according to an embodiment of the invention;

FIG. 4 is a schematic diagram illustrating gesture information according to an embodiment of the invention;

FIGS. 5A-5B are schematic diagrams illustrating a relationship between a static gesture and a dynamic gesture according to an embodiment of the invention;

FIG. 6 is a schematic diagram illustrating a classification tree according to an embodiment of the invention; and

FIG. 7 is a flow chart illustrating a gesture recognition method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

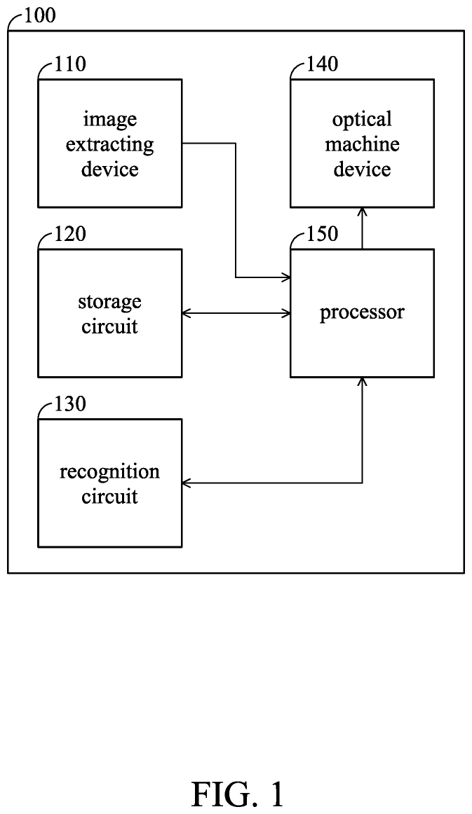

FIG. 1 is a block diagram of a gesture recognition device 100 according to an embodiment of the invention. As shown in FIG. 1, the gesture recognition device 100 may comprise an image extracting device 110, a storage circuit 120, a recognition circuit 130, an optical machine device 140 and a processor 150. It should be noted that FIG. 1 presents a simplified block diagram in which only the elements relevant to the invention are shown. However, the invention should not be limited to what is shown in FIG. 1. The gesture recognition device 100 may also comprise other elements.

According to an embodiment of the gesture recognition device 100 may be an augmented reality (AR) device, e.g., AR helmet, AR glasses, but the invention should not be limited thereto. In addition according to another embodiment, the gesture recognition device 100 may be another electronic device, e.g., cellular phone, tablet, notebook, and so on. In the embodiment, the optical machine device 140 may be the display device of the electronic device.

According to an embodiment of the invention, the image extracting device 110 may be a camera. The image extracting device 110 may be built in or externally connected to the gesture recognition device 100. The image extracting device 110 may be configured to extract the gesture image of the user of the gesture recognition device 100.

The storage circuit 120 may store the software and firmware program codes, system data, etc. of the gesture recognition device 100. The storage circuit 120 may be a volatile memory (e.g. Random Access Memory (RAM)), or a non-volatile memory (e.g. flash memory, Read Only Memory (ROM)), a hard disk, or a combination of the above memory devices. According to an embodiment of the invention, the storage circuit 120 may store a plurality of default gesture patterns in advance.

According to an embodiment of the invention, the gesture patterns stored in the storage circuit 120 may comprise a plurality of static gesture patterns and a plurality of dynamic gesture patterns. Each dynamic gesture pattern may be corresponded to a corresponding static gesture pattern. In addition, each gesture pattern may be corresponded to different function, e.g., open an application, close an application or perform the operations of an application, but the invention should not be limited thereto.

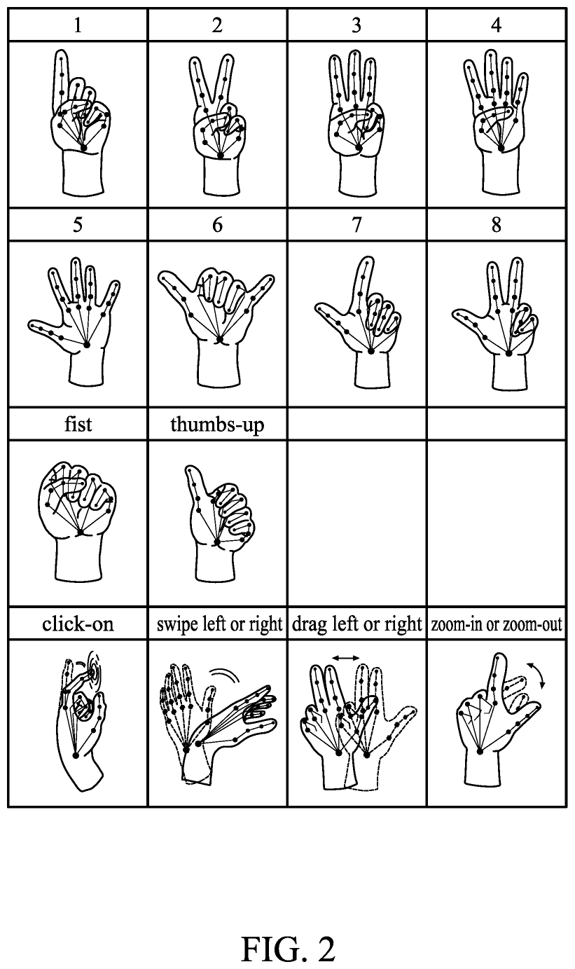

FIG. 2 is a schematic diagram illustrating static gesture patterns and dynamic gesture patterns according to an embodiment of the invention. As shown in FIG. 2, the default static gesture patterns stored in the storage device 120 may comprise the static gesture patterns of “1˜8”, the static gesture pattern of “fist”, and the static gesture pattern of “thumbs-up”. The default dynamic gesture patterns stored in the storage device 120 may comprise the dynamic gesture pattern of “click-on”, the dynamic gesture pattern of “swipe left or right”, the dynamic gesture pattern of “drag left or right”, and the dynamic gesture pattern of “zoom-in or zoom-out”. The dynamic gesture pattern of “click-on” may be corresponded to the static gesture pattern “1”, the dynamic gesture pattern of “swipe left or right” may be corresponded to the static gesture pattern “5”, the dynamic gesture pattern of “drag left or right” may be corresponded to the static gesture pattern “8”, and the dynamic gesture pattern of “zoom-in or zoom-out” may be corresponded to the static gesture pattern “7”. It should be noted that, FIG. 2 is only used to illustrate the embodiments of the invention, but the invention should not be limited thereto. The storage circuit 120 may also store other static gesture patterns and dynamic gesture patterns, and different dynamic gesture patterns may also be corresponded to different static pattern.

According to an embodiment of the invention, according to the gesture image of the user obtained by the image extracting device 110, the recognition circuit 130 may obtain the gesture information corresponding to the gesture image of the user. Then, the recognition circuit 130 may select the matched static gesture pattern or dynamic gesture pattern from the storage circuit 120 according to the gesture information corresponding to the gesture image of the user. In addition, the recognition circuit 130 may perform the function corresponding to the selected static gesture pattern or dynamic gesture pattern. Details of the operations of recognition circuit 130 may be illustrated below.

According to an embodiment of the invention, according to the function, corresponding to the static gesture pattern or dynamic gesture pattern, performed by the recognition circuit 130, the optical machine device 140 may display the pictures or application corresponding to the performed function.

According to an embodiment of the invention, the processor 150 may control the operations of the storage circuit 120, the recognition circuit 130, the optical machine device 140. According to an embodiment of the invention, the processor 150 may also be arranged to execute the program codes of the software module(s) to perform the operations of gesture recognition. The program codes accompanied by specific data in a data structure may also be referred to as a processor logic unit or a stack instance when being executed. Therefore, the processor 150 may be regarded as being comprised of a plurality of processor logic units, each for executing one or more specific functions or tasks of the corresponding software modules.

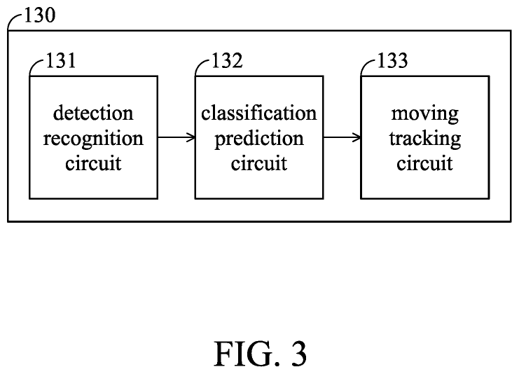

FIG. 3 is a block diagram of the recognition circuit 130 according to an embodiment of the invention. As shown in FIG. 3, the recognition circuit 130 may comprise a detection recognition circuit 131, a classification prediction circuit 132 and a moving tracking circuit 133. According to an embodiment of the invention, the detection recognition circuit 131, the classification prediction circuit 132 and the moving tracking circuit 133 may be combined in a circuit or a chip. According to an embodiment of the invention, the detection recognition circuit 131, the classification prediction circuit 132 and the moving tracking circuit 133 may be realized through soft modules.

According to an embodiment of the invention, the detection recognition circuit 131 may be configured to recognize whether the image extracted by the image extracting device 110 corresponds to a palm according to a deep learning algorithm (e.g., an object recognition algorithm, but the invention should not be limited thereto). That is, the detection recognition circuit 131 may determine whether the image extracted by the image extracting device 110 is a gesture image. When the detection recognition circuit 131 determines that the image extracted by the image extracting device 110 is a gesture image, the detection recognition circuit 131 may transmit the gesture image to the classification prediction circuit 132 to perform the later recognition and calculation.

The classification prediction circuit 132 may be configured to obtain the gesture information corresponding to the gesture image extracted by the image extracting device 110 according to a deep learning algorithm. According to an embodiment of the invention, the deep learning algorithm adopted by the classification prediction circuit 132 may be the POINTLSTM algorithm, MediaPipe Hand algorithm, but the invention should not be limited thereto. According to an embodiment of the invention, the gesture information may comprise the angle information corresponding to each finger (i.e., the angle (i.e., bending angle illustrated in the invention) at which each finger is bent,) and comprise the direction information corresponding to each finger (i.e., the direction in which each finger is pointing).

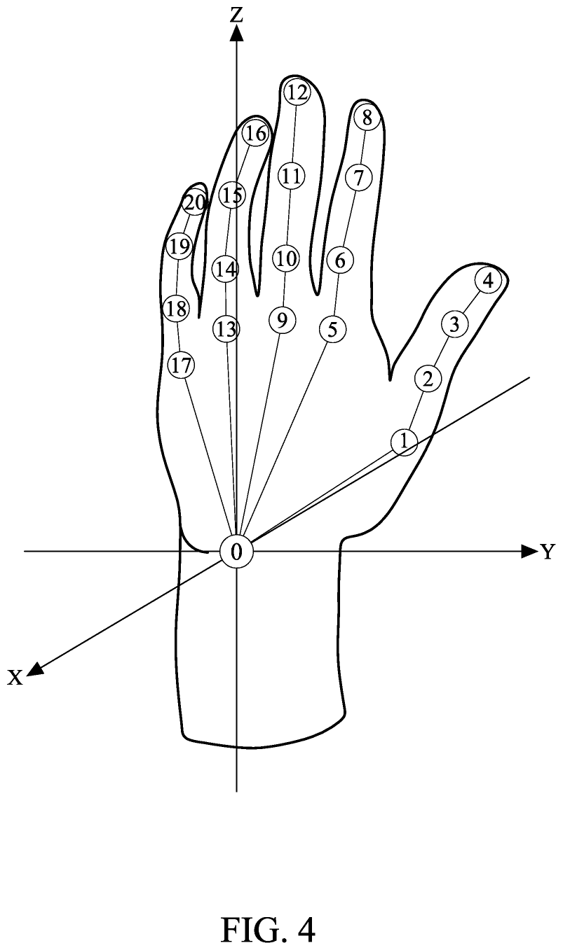

FIG. 4 is a schematic diagram illustrating gesture information according to an embodiment of the invention. As shown in FIG. 4, after the classification prediction circuit 132 uses the deep learning algorithm to calculate the gesture image, the classification prediction circuit 132 may obtain 21 feature points (the thumb corresponds to feature points 1˜4, the index finger corresponds to the feature points 5˜8, the middle finger corresponds to feature points 9˜12, the ring finger corresponds to the feature points 13˜16, the little finger corresponds to the feature point 17˜20, and center of palm corresponds to feature point 0).

The classification prediction circuit 132 may determine the bending angle of each finger in the space (i.e., XYZ axis) according to the feature points of the gesture image. For example, if the user makes a gesture “1”, the classification prediction circuit 132 may determine the spatial vector from the feature point 0 to feature 6 is A and determine the spatial vector from the feature point 6 to feature point 8 is B. Then, the classification prediction circuit 132 may calculate the bending angle θ of index finger is 150˜180 degrees according to the formula, cos θ=B/A. Accordingly, if the user makes a gesture “1”, the classification prediction circuit 132 may calculate the bending angles of the thumb and little finger is 50˜100 degrees, and the bending angles of the middle finger and ring finger is 0˜50 degrees. According to an embodiment of the invention, the classification prediction circuit 132 may also determine the curvature of each finger according to the bending angles of each finger.

Then, the classification prediction circuit 132 may determine the direction vector of each finger in the space according to the feature points in the gesture image. According to an embodiment of the invention, the classification prediction circuit 132 may determine the direction vector of each finger based on the clock direction. For example, if the user makes a gesture “1”, the classification prediction circuit 132 may determine the thumb is 3 o'clock direction, the index finger is the 12 o'clock direction, the middle finger is the 7 o'clock direction, the ring finger is the 7 o'clock direction and the little finger is the 8 o'clock direction. After the classification prediction circuit 132 obtains the gesture information (i.e., the bending angle (or curvature) of each finger in the space) corresponding to the gesture image, the classification prediction circuit 132 may compare the gesture image to the static gesture patterns stored in the storage circuit 120 according to the gesture information to select the static gesture pattern which is most similar to the gesture image.

According to an embodiment of the invention, the classification prediction circuit 132 may use the two data structures, FingerCurls and FingerDirections to record the curvature and direction of each finger in the gesture image. For example, it is assumed that the curvature of fingers is pre-defined as follows, 0 is defined as non-curved (e.g., 150˜180 degrees), 1 is defined as slightly-curved (e.g., 100˜150 degrees), 2 is defined as half-curved (e.g., 50˜100 degrees) and 3 is defined as fully-curved (e.g., 0˜50 degrees). When the user make the gesture “2”, the classification prediction circuit 132 may record the gesture information of the gesture image by FingerCurls: [2, 0, 0, 3, 3] and FingerDirections: [3, 11, 1, 8, 8]. FingerCurls: [2, 0, 0, 3, 3] means that the curvature of the thumb is half-curved, the curvature of the index finger is non-curved, the curvature of the middle finger is non-curved, the curvature of the ring finger is fully-curved, and the curvature of the little finger is fully-curved. FingerDirections: [3, 11, 1, 8, 8] means that the direction of the thumb is 3 o'clock direction, the direction of the index finger is 11 o'clock direction, the direction of the middle finger is 1 o'clock direction, the direction of the ring finger is 8 o'clock direction, and the direction of the little finger is 8 o'clock direction.

According to an embodiment of the invention, the values recoded via FingerDirections: [3, 11, 1, 8, 8] may have the compatibility by plus 2 or minus 2. For example, 3 o'clock direction may be equivalent to 1 o'clock direction˜4 o'clock direction.

When the classification prediction circuit 132 obtains the values of FingerCurls and FingerDirections, the classification prediction circuit 132 may record the gesture information of each finger in the gesture image according to the values of FingerCurls and FingerDirections. For example, when the user makes the gesture “2”, the classification prediction circuit 132 may record the gesture information by [[Thumb, 2, 3], [Index, 0, 11], [Middle, 0, 1], [Ring, 3, 8], [Pinky, 3, 8]]. The classification prediction circuit 132 may compare the content of gesture information to the static gesture patterns stored in the storage circuit 120, and then select the static gesture pattern with the highest comparison score as a predicted static gesture pattern corresponding to the gesture image.

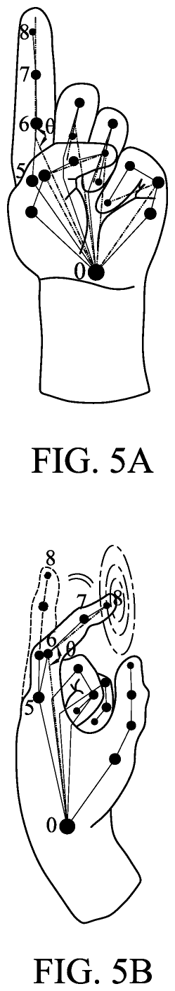

After the classification prediction circuit 132 obtains the predicted static gesture pattern corresponding to the gesture image, the moving tracking circuit 133 may determine whether the current gesture image may correspond to a dynamic gesture pattern. Specifically, the moving tracking circuit 133 may determine whether the current gesture image and the prior gesture image correspond to the same static gesture pattern. If the current gesture image and the prior gesture image correspond to the different static gesture patterns, the moving tracking circuit 133 may perform the function corresponding to the static gesture pattern corresponding to the current gesture image. If the current gesture image and the prior gesture image correspond to the same static gesture pattern, the moving tracking circuit 133 may determine whether the current gesture image corresponds to a dynamic gesture pattern according to the gesture information of the current gesture image and the gesture information of the prior gesture image (i.e., the moving tracking circuit 133 may determine whether gesture pattern of the current gesture image is the dynamic gesture image corresponding to the static gesture pattern corresponding to the prior gesture image). When the moving tracking circuit 133 determines that the current gesture image corresponds to a dynamic gesture image (i.e., the current gesture image may correspond to the dynamic image corresponding to the static gesture pattern), the moving tracking circuit 133 may perform the function corresponding to the dynamic gesture pattern corresponding to the current gesture image. When the moving tracking circuit 133 determines that the current gesture image does not correspond to a dynamic gesture image (i.e., the current gesture image may not correspond to the dynamic image corresponding to the static gesture pattern), the moving tracking circuit 133 may maintain the function of the static gesture pattern (i.e., the predicted static gesture pattern) corresponding to the current gesture image. FIGS. 5A-5B are used as example for illustrating.

FIGS. 5A-5B are schematic diagrams illustrating a relationship between a static gesture and a dynamic gesture according to an embodiment of the invention. As shown in FIG. 5A, the recognition circuit 130 may determine that the gesture image extracted by the image extracting device 110 at the first time point corresponds to the static gesture pattern “1”. In addition, as shown in FIG. 5B, the recognition circuit 130 may determine that the gesture image extracted by the image extracting device 110 at the second time point (i.e., the next time point) also corresponds to the static gesture pattern “1”. Therefore, the recognition circuit 130 may determine whether the gesture image at the second time point corresponds to the dynamic gesture pattern (i.e., the dynamic gesture pattern of “click-on”) corresponding to the static gesture pattern “1” according to the gesture information of the gesture image at the first time point and the gesture information of the gesture image at the second time point.

As shown in FIG. 5B, when the recognition circuit 130 determines that the bending angle of the index finger changes from 180 degrees to 120 degrees, and the direction vector of the index finger changes from 12 o'clock direction to 2 o'clock direction according to the gesture information of the gesture image at the first time point and the gesture information of the gesture image at the second time point, the recognition circuit 130 may determine that the gesture image at the second time point corresponds to the dynamic gesture pattern (i.e., the dynamic gesture pattern of “click-on”) corresponding to the static gesture pattern “1”. Then, the recognition circuit 130 may perform the function corresponding to the dynamic gesture pattern (i.e., the dynamic gesture pattern of “click-on”) corresponding to the static gesture pattern “1”.

According to an embodiment of the invention, the moving tracking circuit 133 may also determine whether the current gesture image corresponds to a dynamic gesture pattern according to the gesture information of the gesture images (two or more than two gesture images) extracted continuously by the image extracting device 110 during a default time period (e.g., 2 second).

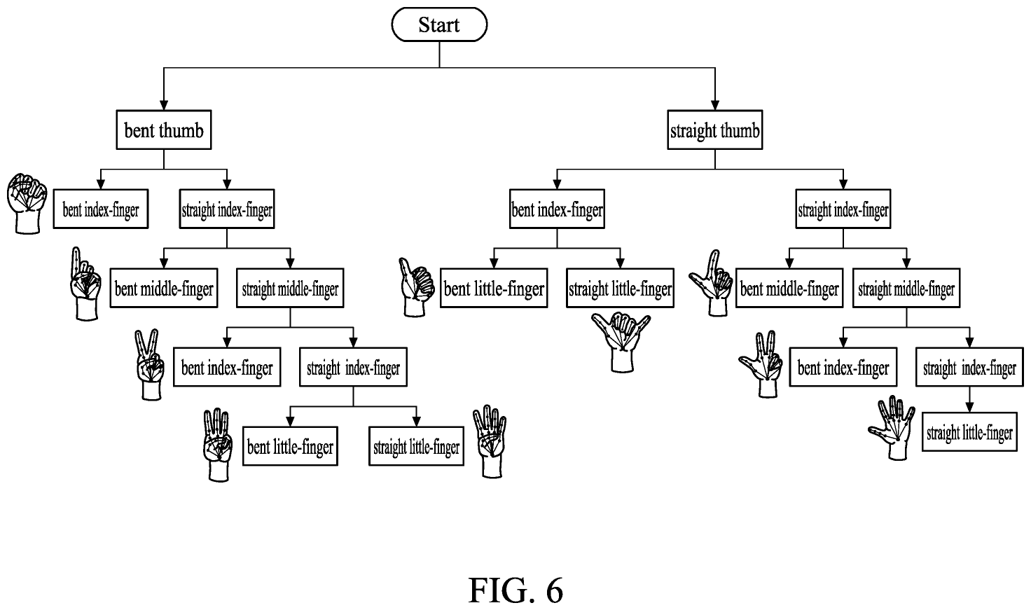

According to an embodiment of the invention, the classification prediction circuit 132 may further determine the static gesture pattern corresponding to the gesture image by referring to a classification tree to save the calculation time of the classification prediction circuit 132. FIG. 6 is a schematic diagram illustrating a classification tree according to an embodiment of the invention. As shown in FIG. 6, the classification prediction circuit 132 may determine the gesture image corresponds to the type of “bent thumb” or the type of “straight thumb” according to the gesture information of the gesture image. If the gesture image corresponds to the type of “bent thumb”, the classification prediction circuit 132 may only need to select the static gesture pattern from the static gesture patterns corresponding to the type of “bent thumb” without comparing to all static gesture patterns. Therefore, the classification prediction circuit 132 may reduce the time of determining the static gesture pattern corresponding to the gesture image. It should be noted that FIG. 6 is only used to illustrate the embodiment of the invention, but the invention should not be limited thereto. The classification prediction circuit 132 may also adopt other classification trees.

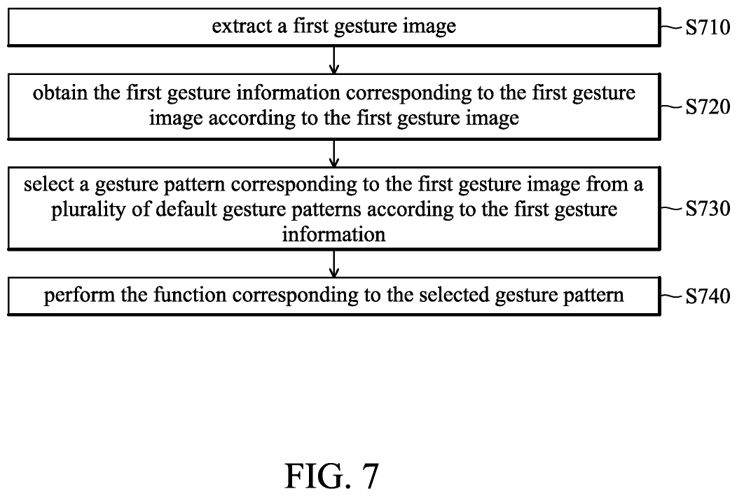

FIG. 7 is a flow chart illustrating a gesture recognition method according to an embodiment of the invention. The gesture recognition method can be applied to the gesture recognition device 100. As shown in FIG. 7, in step S710, the gesture recognition device 100 may extract a first gesture image.

In step S720, the gesture recognition device 100 may obtain the first gesture information corresponding to the first gesture image according to the first gesture image.

In step S730, the gesture recognition device 100 may select a gesture pattern corresponding to the first gesture image from a plurality of default gesture patterns according to the first gesture information.

In step S740, the gesture recognition device 100 may perform the function corresponding to the selected gesture pattern.

According to an embodiment of the invention, in the gesture recognition method, the gesture patterns may comprise a plurality of static gesture patterns and a plurality of dynamic gesture patterns. Each dynamic gesture pattern may correspond to one of the static gesture patterns.

According to an embodiment of the invention, in the gesture recognition method, the gesture recognition device 100 may further select a static gesture image corresponding to the first gesture image from the static gesture images according to the first gesture information.

According to an embodiment of the invention, in the gesture recognition method, the gesture recognition device 100 may extract a second gesture image at the next time point. Then, the gesture recognition device 100 may obtain the second gesture information corresponding to the second gesture image. In addition, the gesture recognition device 100 may determine whether the second gesture image corresponds to the dynamic gesture pattern corresponding to the selected static gesture pattern according to the first gesture information and the second gesture information.

When the gesture recognition device 100 determines that the second gesture image corresponds to the dynamic gesture pattern corresponding to the selected static gesture pattern, the gesture recognition device 100 may perform the function corresponding to the selected dynamic gesture pattern.

When the gesture recognition device 100 determines that the second gesture image does not correspond to the dynamic gesture pattern corresponding to the selected static gesture pattern, the gesture recognition device 100 may perform the function corresponding to the static gesture corresponding to the second gesture image according to the static gesture corresponding to the second gesture image.

According to an embodiment of the invention, in the gesture recognition method, the gesture recognition device 100 may further select a static gesture image corresponding to the first gesture image from the static gesture images according to a classification tree.

According to an embodiment of the invention, in the gesture recognition method, the gesture recognition device 100 may further obtain the first gesture information corresponding to the first gesture image according to a deep learning algorithm.

According to an embodiment of the invention, in the gesture recognition method, the first gesture information may comprise the angle information and direction information of fingers.

According to the gesture recognition provided in the invention, the gesture recognition device may recognize the gesture through the images from one camera. In addition, according to the gesture recognition provided in the invention, the gesture recognition device may perform many functions according to different static gesture patterns and dynamic gesture patterns. Therefore, the user may use the reality (AR) device more intuitively and conveniently.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. Alternatively, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A gesture recognition device, comprising:
an image extraction device, extracting a first gesture image;
a storage circuit, storing a plurality of gesture patterns; and
a recognition circuit, obtaining first gesture information corresponding to the first gesture image according to the first gesture image, selecting a gesture pattern corresponding to the first gesture image from the plurality of gesture patterns according to the first gesture information, and performing a function corresponding to the selected gesture pattern.

2. The gesture recognition device of claim 1, further comprising:
an optical machine device, displaying a display result corresponding to the function.

3. The gesture recognition device of claim 1, wherein the plurality of gesture patterns comprise a plurality of static gesture patterns and a plurality of dynamic gesture patterns, wherein each dynamic gesture pattern corresponds to one of the plurality of static gesture patterns.

4. The gesture recognition device of claim 3, wherein the recognition circuit selects a static gesture pattern corresponding to the first gesture image from the plurality of static gesture patterns according to the first gesture information.

5. The gesture recognition device of claim 4, wherein the recognition circuit further obtains second gesture information corresponding to a second gesture image according to the second gesture image extracted by the image extracting device at a next time point, and determines whether the second gesture image corresponds to a dynamic gesture pattern corresponding to the selected static gesture pattern according to the first gesture information and the second gesture information.

6. The gesture recognition device of claim 5, wherein when the recognition circuit determines that the second gesture image corresponds to the dynamic gesture pattern corresponding to the selected static gesture pattern, the recognition circuit performs the function corresponding to the dynamic gesture pattern.

7. The gesture recognition device of claim 5, wherein when the recognition circuit determines that the second gesture image does not correspond to the dynamic gesture pattern corresponding to the selected static gesture pattern, the recognition circuit performs the function corresponding to the static gesture pattern corresponding to the second gesture image.

8. The gesture recognition device of claim 4, wherein the recognition circuit further selects the static gesture pattern corresponding to the first gesture image from the plurality of static gesture patterns according to a classification tree.

9. The gesture recognition device of claim 1, wherein the recognition circuit further obtains the first gesture information corresponding to the first gesture image according to a deep learning algorithm.

10. The gesture recognition device of claim 1, wherein the first gesture information comprises angle information and direction information corresponding to fingers.
